(19) United States
(12) Patent Application Publication
(10) Pub. No.: US 2013/0065009 A1
(43) Pub. Date: Mar. 14, 2013

(54) EMBOSSED SHEET AND METHOD OF MANUFACTURING THE SAME

(71) Applicants: Ryuichi Katsumoto, Saitama-shi (JP); Ryo Hibino, Saitama-shi (JP); Takashi Shimizu, Saitama-shi (JP)

(72) Inventors: Ryuichi Katsumoto, Saitama-shi (JP); Ryo Hibino, Saitama-shi (JP); Takashi Shimizu, Saitama-shi (JP)

(73) Assignee: FUJIFILM CORPORATION, Minato-ku, Tokyo (JP)

(21) Appl. No.: 13/634,349

(22) PCT Filed: Feb. 22, 2012
(86) PCT No.: PCT/JP2012/054218

§ 371 Date: Sep. 12, 2012

(30) Foreign Application Priority Data
Mar. 25, 2011 (JP) 2011-068591

(51) Int. Cl. B32B 3/04; B29C 53/04

(52) U.S. Cl. CPC B32B 3/04; B29C 53/043
USPC 428/68; 156/202; 428/126

(57) ABSTRACT

An embossed sheet 40, which is a strip-like sheet on a surface of which an embossed pattern 30 is formed and which is rolled up, includes band-like bump portions 34 formed on widthwise both end portions of the sheet along a longitudinal direction of the sheet to be thicker than the other portions of the sheet.

### TECHNICAL FIELD

The present invention relates to an embossed sheet and a method of manufacturing the same, and in particular to an embossed sheet and a method of manufacturing the same, wherein an embossed pattern, which is used as a lens, is formed on one surface of a sheet, and the sheet is rolled up in the course of manufacturing the same.

### BACKGROUND ART

An embossed sheet made of resin and used in various optical elements involves a Fresnel lens, a lenticular lens, and the like, and is used in various fields. Such an embossed sheet has a surface on which a regular embossed pattern, which is used as a lens, is formed, and this embossed pattern provides optical performance. As a method for manufacturing such an embossed sheet, there are generally an extrusion molding method, an extrusion laminating method, and a 2P method. The extrusion molding method is such that a strip-like resin sheet obtained by extruding thermoplastic molten resin in a sheet-like shape from an extrusion die is nipped between a die roller and a nip roller, the inverted shape of an embossed pattern formed on the die roller is transferred to the resin sheet, and the resin sheet after the transfer is separated from the die roller. Then, the separated strip-like embossed sheet is rolled up by a winder. In addition, the extrusion laminating method is the same as the extrusion molding method, except that a strip-like base material is laminated as a support on a resin sheet extruded from an extrusion die.

The 2P method is such that after UV (ultraviolet) curable resin is applied to a support, the support is wrapped on a die roller and is irradiated with UV light while being wrapped, so that a reversal shape of an embossed pattern formed on the die roller is transferred to the resin sheet, and the resin sheet after the transfer is separated from the die roller. Then, the separated strip-like embossed sheet is rolled up by a winder.

As shown in FIG. 9, however, unlike a resin sheet having a flat sheet surface, an embossed sheet 2 having a sheet surface on which an embossed pattern 1 is formed has the problem that when the embossed sheet 2 is rolled around a take-up shaft 3 of the winder, as shown by a part (A) of FIG. 9, protrusions 1A of the embossed pattern 1 are crushed, as shown by a part (B) of FIG. 9, by winding pressure due to winding tension, resulting in such a problem that optical performance cannot be exerted.

Regarding a technique of rolling up a sheet or a film, a patent literature 1, for example, describes a technique of performing knurling to form a lot of spherical protrusions on both widthwise end portions of a film, thereby preventing misalignment of roll layers when the film is rolled up.

In addition, a patent literature 2 introduces a technique improved from the patent literature 1. That is, since the spherical protrusions are not sufficiently formed by knurling an unsoftened film after being manufactured like the patent literature 1, the patent literature 2 suggests knurling, by an emboss roller, a softened film when the film is formed in an extruding manner.

### CITATION LIST

### Patent Literature

PTL 1: Japanese Patent Application Laid-Open No. H09-52285
PTL 2: Japanese Patent Application Laid-Open No. 2002-301751

### SUMMARY OF INVENTION

### Technical Problem

However, though making it possible to prevent misalignment of roll layers, knurling in the patent literatures 1 and 2 cannot make it possible to prevent protrusions of an embossed pattern formed on a sheet surface from being crushed when the embossed sheet is rolled up. That is, the patent literatures 1 and 2 do not present the problem of preventing protrusions of an emboss pattern formed on a sheet surface from being crushed when the embossed sheet is rolled up, and do not take a measure to solve the problem, either. In particular, if the embossed sheet has thickness distribution in a product region where the embossed pattern is formed, thicker portions are subjected to winding pressure, by which only the protrusions at the thicker portions might be deformed into an embossed line.

The present invention has been made in view of these circumstances, and an object thereof is to provide an embossed sheet and a method of manufacturing the same, wherein an embossed pattern is prevented from being crushed when the embossed sheet is rolled up so that the embossed pattern can provide its original function, such as optical performance.

### Solution to Problems

In order to achieve the object, an embossed sheet of the present invention is an embossed sheet obtained by forming an embossed pattern on a surface of a strip-like sheet and rolled up, including band-like bump portions thicker than the other portions of the sheet, the band-like bump portions being formed on widthwise both end portions of the sheet along a longitudinal direction of the sheet.

According to the embossed sheet of the present invention, the band-like bump portions thicker than the other portions of the sheet are formed on widthwise both end portions of the sheet along a longitudinal direction of the sheet. Therefore, when the embossed sheet is rolled up, the band-like bump portions come into contact with the band-like bump portions on the embossed sheet wound thereon. As a result, a clearance due to the band-like bump portions is formed between roll layers of the rolled-up embossed sheet.

Thus, since winding pressure of winding tension when the embossed sheet is rolled up can be borne by the band-like bump portions, the winding pressure is not applied to protrusions of the embossed pattern, or, if any, the winding pressure can be remarkably reduced as compared with the embossed sheet having no band-like bump portions. Therefore, since the embossed pattern formed on the sheet surface is prevented from being crushed when the embossed sheet is rolled up, the embossed pattern can provide its original function, such as optical performance.

In the embossed sheet of the present invention, it is preferred that the embossed sheet has a structure where a strip-like base member is laminated on a resin sheet on which the embossed pattern is formed and the band-like bump portions are formed by folding and bonding both end portions of the resin sheet formed to be wider than the strip-like base member to a rear surface of the strip-like base member.

It should be noted that both end portions of the resin sheet formed to be wider than the strip-like base member are referred to as “extended portions”.

This is a preferred aspect of forming the band-like bump portions, and since the extended portions of the resin sheet formed to be wider than the strip-like base member are folded and bonded to the rear surface of the strip-like base member, the band-like bump portions can be formed easily and reliably. In this case, it is preferred that the band-like bump portions include protrusions on widthwise both end portions of the embossed pattern, and the embossed pattern between the band-like bump portions formed in a widthwise direction of the embossed sheet is produced as a product region.

Thus, since the band-like bump portions include the protrusions on widthwise both end portions of the embossed pattern, a clearance corresponding to the thickness of the extended portion can be reliably formed between roll layers of the rolled-up embossed sheet.

In the embossed sheet of the present invention, it is preferred that the embossed sheet has a structure where a strip-like base member is laminated on a resin sheet on which the embossed pattern is formed and the band-like bump portions are formed by folding both end portions of the resin sheet formed to be wider than the strip-like base member to overlap with protrusions on widthwise both end portions of the embossed pattern formed on the resin sheet, and bonding both end portions of the resin sheet to the protrusions.

This is a preferred aspect of forming the band-like bump portions, and since the extended portions are folded to overlap with the protrusions on widthwise both end portions of the embossed pattern and are bonded thereto, a clearance corresponding to the thickness of the extended portion can be reliably formed between roll layers of the rolled-up embossed sheet.

In the embossed sheet of the present invention, it is preferred that the embossed pattern has optical performance. Crushing protrusions of an embossed pattern having optical performance, such as a lenticular lens, is particularly problematic.

In order to achieve the above object, a method of manufacturing an embossed sheet of the present invention is a method of manufacturing an embossed sheet on a sheet surface of which an embossed pattern is formed, including: a strip-like base member supplying step of supplying a strip-like base member from a feeder to a nip point between a die roller and a nip roller; a resin sheet supplying step of extruding thermoplastic molten resin from an extrusion die into a sheet-like shape, thereby forming a strip-like resin sheet wider than the strip-like base member, and supplying the formed resin sheet to the nip point between the die roller and the strip-like base member; a transferring step of nipping the resin sheet and the strip-like base member supplied to the nip point by the die roller and the nip roller, thereby laminating the resin sheet on the strip-like base member, and transferring an inverted shape of the embossed pattern formed on the die roller to the resin sheet, and thereafter cooling solidifying the resin sheet; a separating step of separating the strip-like base member laminated with the resin sheet from the die roller after the transferring step; a folding step of folding both end portions of the wider resin sheet to a rear surface of the strip-like base member after the separating step; a bonding step of bonding the folded portions to the strip-like base member; and a rolling-up step of rolling up the strip-like base member laminated with the resin sheet after the bonding step.

According to the manufacturing method of the present invention, band-like bump portions can be formed on widthwise both end portions of the sheet along a longitudinal direction of the sheet to be thicker than the other portions of the sheet.

Thus, since the band-like bump portions function as bridge beams even when the embossed sheet is rolled up, the embossed pattern is prevented from being crushed. Therefore, the embossed sheet can provide an original function of the embossed pattern, such as optical performance.

In addition, since the band-like bump portions are formed by folding both end portions of the wider resin sheet to the rear surface of the strip-like base member and bonding the same thereto, the band-like bump portions can be formed easily and reliably.

In the method of manufacturing an embossed sheet of the present invention, it is preferred that the resin sheet and an adhesive resin layer are coextruded from the extrusion die such that the adhesive resin layer is formed on a rear surface of the resin sheet extruded from the extrusion die.

This makes it possible to perform simultaneously the step of folding both end portions of the wider resin sheet to the rear surface of the strip-like base member and the step of bonding the same thereto.

In order to achieve the above object, a method of manufacturing an embossed sheet of the present invention is a method of manufacturing an embossed sheet on a sheet surface of which an embossed pattern is formed, including: a strip-like base member supplying step of supplying a strip-like base member from a feeder to a nip point between a die roller and a nip roller; a resin sheet supplying step of extruding thermoplastic molten resin from an extrusion die into a sheet-like shape, thereby forming a strip-like resin sheet wider than the strip-like base member, and supplying the formed resin sheet to the nip point between the die roller and the strip-like base member; a transferring step of nipping the resin sheet and the strip-like base member supplied to the nip point by the die roller and the nip roller, thereby laminating the resin sheet on the strip-like base member, and transferring an inverted shape of the embossed pattern formed on the die roller to the resin sheet, and thereafter cooling and solidifying the resin sheet; a separating step of separating the strip-like base member laminated with the resin sheet from the die roller after the transferring step; a folding step of folding both end portions of the wide resin sheet to overlap with a portion of the embossed pattern on the resin sheet after the separating step; a bonding step of bonding the folded portions to the overlapped portions of the resin sheet; and a rolling-up step of rolling up the strip-like base member laminated with the resin sheet after the bonding step.

This is another aspect for forming the band-like bump portions easily and reliably, where both end portions of the wide resin sheet are folded to overlap with a portion of the embossed pattern on the resin sheet, and are bonded to the portion of the embossed pattern.

In addition, it is preferred that the rigidity of the strip-like base member to be used is higher than the rigidity of the resin sheet. The rigidity of the embossed sheet manufactured by laminating the resin sheet on the strip-like base member having higher rigidity than the resin sheet can be made higher than the rigidity of an embossed sheet made of only a resin sheet. This makes the embossed sheet between the band-like bump portions less likely to sag when the embossed sheet is rolled up, and therefore the function of the band-like bump portions as bridge beams can be further enhanced. If the rigidity of the embossed sheet is low and therefore the embossed sheet between the band-like bump portions sags, the embossed pattern distant from the band-like bump portions becomes more likely to be crushed while the embossed pattern near the band-like bump portions are prevented from being crushed.

### Advantageous Effects of Invention

According to the embossed sheet and the method of manufacturing the same of the present invention, the embossed pattern is prevented from being crushed when the embossed sheet is rolled up, and therefore the embossed pattern can provide its original function, such as optical performance.

### BRIEF DESCRIPTION OF DRAWINGS

FIG. 1 is a schematic side view of a manufacturing apparatus that performs a method of manufacturing an embossed sheet of an embodiment of the present invention;

FIG. 2 is a partial perspective view of the manufacturing apparatus in FIG. 1;

FIG. 3 is an illustration showing an example of a reversal shape formed on a roller surface of a die roller;

FIG. 4 is an illustration of a forming method for strip-like bump portions which are formed at both end portions of the embossed sheet;

FIG. 5 is a perspective view of the embossed sheet whose embossed pattern is a lenticular lens;

A part (A) of FIG. 6 is an illustration describing the function of the strip-like bump portion when the embossed sheet is rolled up, and a part (B) of FIG. 6 is a sectional view taken along line A-A in the part (A) of FIG. 6;

FIG. 7 is an illustration describing formation of the band-like bump portion in another aspect;

FIG. 8 is an illustration of the embossed sheet having the embossed pattern in another aspect; and

FIG. 9 is an illustration describing crushing of protrusions of an embossed pattern when an embossed sheet is rolled up.

### DESCRIPTION OF EMBODIMENTS

Hereinafter, preferred embodiments of an embossed sheet and a method of manufacturing the same of the present invention will be described with reference to the accompanying drawings.

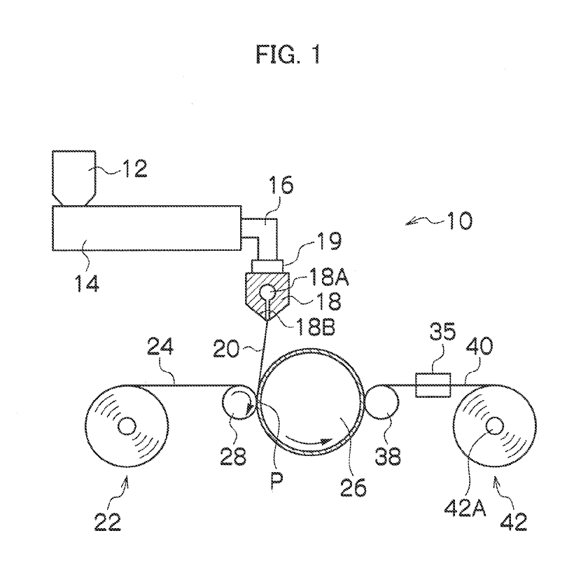

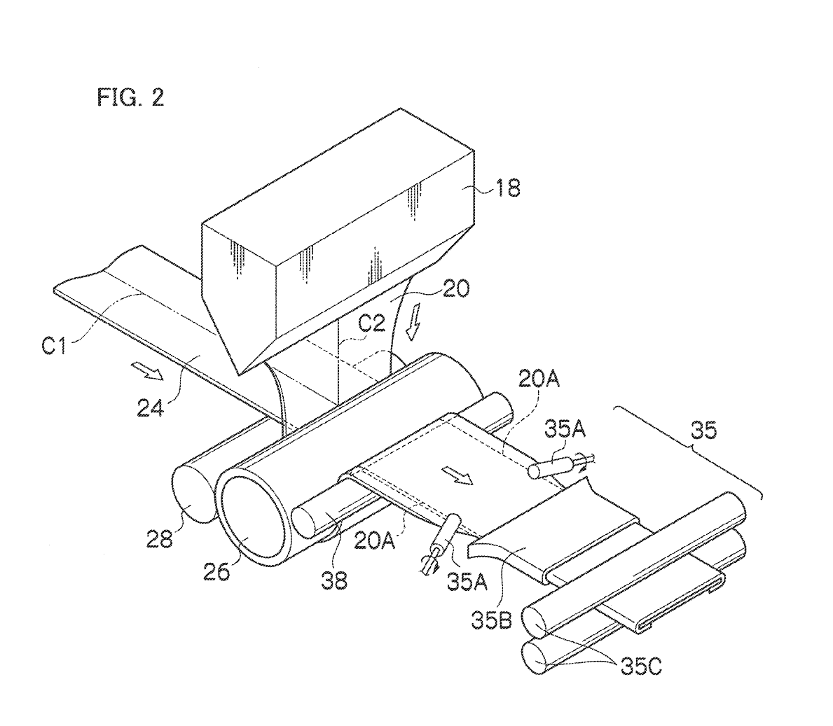

FIG. 1 is a schematic side view of a manufacturing apparatus 10 that performs a method of manufacturing an embossed sheet in an embodiment of the present invention, and FIG. 2 is a partial perspective view of the manufacturing apparatus 10.

As shown in FIGS. 1 and 2, dried thermoplastic raw resin is put into an extruder 14 through a hopper 12, and melted while being mixed and kneaded. The extruder 14 may be either a single screw extruder or a multi-screw extruder, or may include a venting function to form a vacuum in the extruder 14.

Next, the molten resin melted by the extruder 14 is fed to an extrusion die 18 through a feed pipe 16. The extrusion die 18 is mainly composed of a manifold 18A through which the molten resin fed from the extruder 14 flows so as to spread in a widthwise direction of the die, and a slit 18B that is a narrow channel through which the molten resin flowing in a spread manner is extruded outward in a sheet shape.

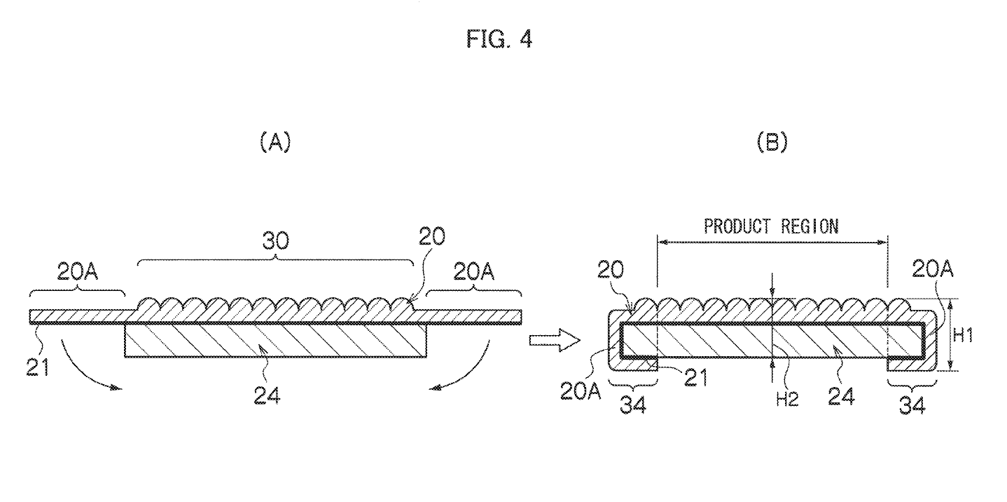

In this case, it is preferred that a feed block 19, which can merge a plurality of molten resins into a multilayered molten resin, is provided between the feed pipe 16 and the extrusion die 18 so that a resin sheet 20 and an adhesive resin layer 21 (see FIG. 4) are coextruded. It should be noted that FIG. 1 omits to show an extruder that melts the adhesive resin layer 21.

Then, a strip-like base member 24 is fed from a feeder 22 to be supplied to a nip point P between a die roller 26 and a nip roller 28, the respective rollers rotating in directions indicated by arrows, while the resin sheet 20 which is wider than the strip-like base member 24 is extruded from the extrusion die 18 to be supplied to the nip point P. In this case, as shown in FIG. 2, the strip-like base member 24 and the resin sheet 20 are supplied such that a central line C1 of the strip-like base member 24 and a central line C2 of the resin sheet 20 coincide with each other. In other words, when the wider resin sheet 20 is laminated on the strip-like base member 24, the widths of both end portions of the resin sheet 20 that are extended beyond the strip-like base member 24 (hereinafter referred to as “extended portion 20A”: see FIG. 4) are equal to each other.

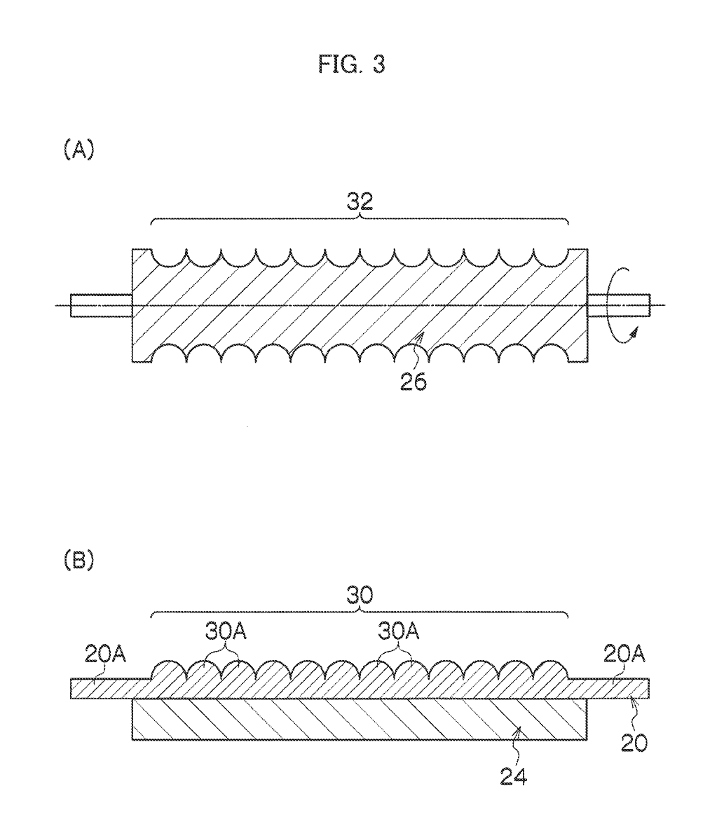

In addition, as shown by parts (A) and (B) of FIG. 3, an inverted shape 32 of an embossed pattern 20 to be transferred to the resin sheet 20 is formed on a roller surface of the die roller 26. In addition, a cooling means (not shown) to keep the roller surface at low temperature is provided in the die roller 26.

Thus, when the resin sheet 20 and the strip-like base member 24 are nipped by the die roller 26 and the nip roller 28, the resin sheet 20 is laminated on the strip-like base member 24, and the inverted shape 32 of the die roller 26 is transferred to the resin sheet 20 so that the embossed pattern 30 is formed on the resin sheet 20.

Then, during conveyance of the strip-like base member 24 from the nip position P to the position of a separation roller 38 (see FIGS. 1 and 2) according to rotation of the die roller 26, the resin sheet 20 in contact with the roller surface of the die roller 26 is cooled and solidified so that the transferred embossed pattern 30 is fixed.

Next, as shown in FIG. 1, the strip-like base member 24 with the embossed pattern transferred on the surface of the resin sheet 20 is separated from the die roller 26 by the separation roller 38.

The separated strip-like base member 24 passes through a folding device 35. This folding device 35 is a device to fold the extended portions 20A of the wide resin sheet 20 to a rear surface of the strip-like base member 24 and bond them to the strip-like base member 24. Though any folding device is applicable as long as the folding device can perform such folding, for example, as shown in FIG. 2, a device composed of a combination of folding rollers 35A, a folding tube 35B, and a pair of upper and lower pressure rollers 35C can be used. The folding rollers 35A are provided in a pair with a distance equal to the width of the strip-like base member 24 therebetween, and abut on the extended portions 20A at both ends of the resin sheet 20 while being inclined in an inverted-V shape. Thus, the extended portions 20A are folded down in directions of arrows in a part (A) of FIG. 4 along both ends of the strip-like base member 24.

A guide plate, which can fold the extended portions 20A of the resin sheet 20 to the rear surface of the strip-like base member 24 according to advance of the strip-like base member 24, is formed in the folding tube 35B. Thus, as shown by a part (B) of FIG. 4, the extended portions 20A are folded to the rear surface of the strip-like base member 24. The extended portions 20A folded to the rear surface thereof are nipped from above and below by the pressure rollers 35C, and the extended portions 20A are bonded to the rear surface of the strip-like base member 24 through an adhesive resin layer 21. Thus, band-like bump portions 34 is formed on widthwise both ends of the sheet along a longitudinal direction of the sheet. Thus, band-like bump portions 34 are formed on both end portions of the sheet in the widthwise direction so as to extend along in the longitudinal direction of the sheet. A thickness H1 of the band-like bump portion 34 becomes thicker than a thickness of H2 of the other portion of the sheet. As shown by the part (B) of FIG. 4, it should be noted that the embossed pattern 30 included in the band-like bump portions 34 of the resin sheet 20 lies in a non-product region, while the embossed pattern 30 included in the other portion of the resin sheet constitutes a product region.

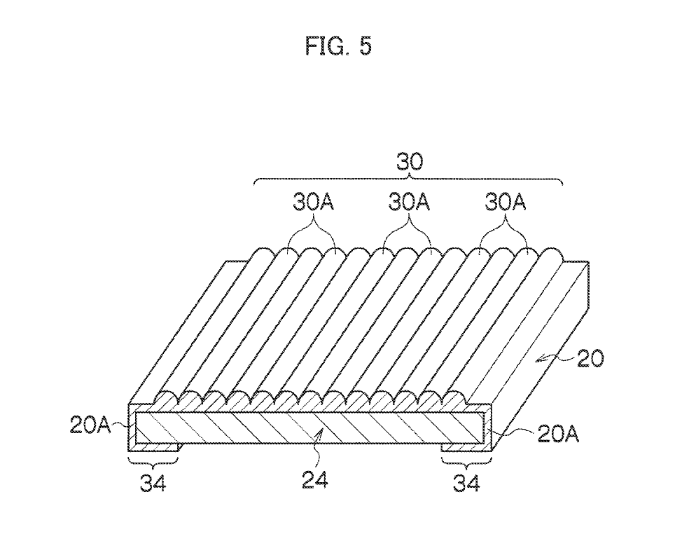

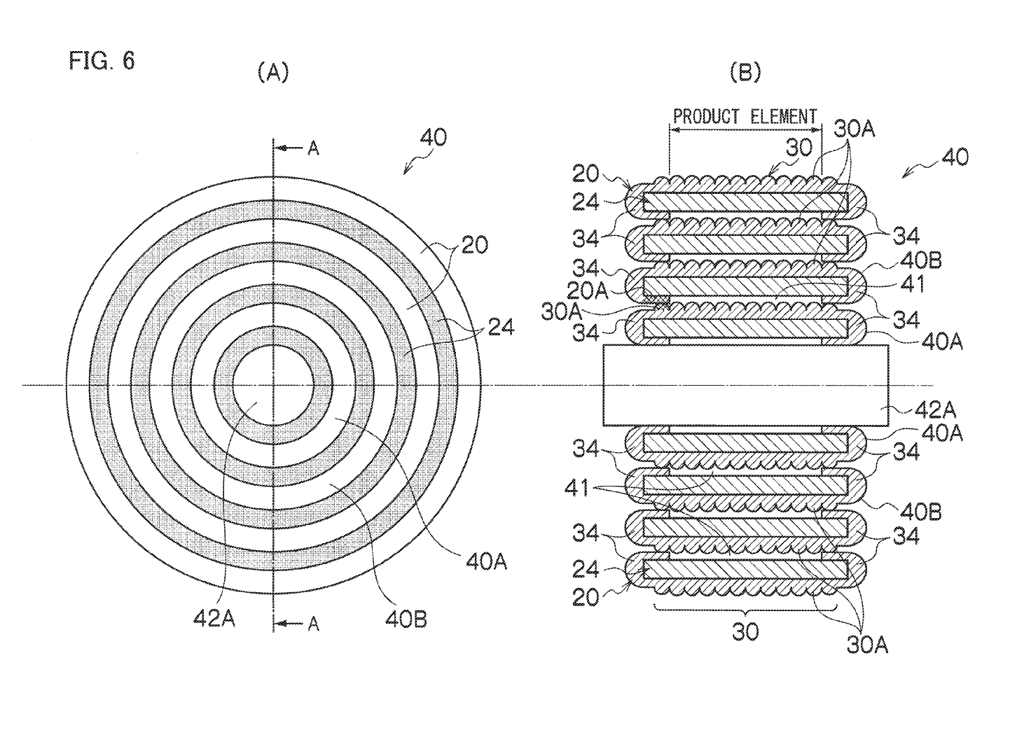

Thus, as shown in FIG. 5, an embossed sheet 40 provided with, for example, a lenticular lens, as the embossed pattern 30 and having the band-like bump portions 34 extending along the longitudinal direction of the sheet on the both end portions in the widthwise direction of the sheet is formed. In the case of the lenticular lens, it is preferred that the lenticular lens is provided on a surface where the thickness (corresponding to H) of the whole resin sheet is in a range of 50 to 300 μm. It is preferred that the shape of a lenticular lens is formed while having a radius of curvature (R) of 100 to 200 μm, a lens height (h) of 30 to 100 μm, and a span (S) of 100 to 318 μm.

Finally, as shown in FIG. 1, the embossed sheet 40 is rolled on a take-up shaft 42A of a winder 42.

Next, a function effect when the embossed sheet 40 thus manufactured is rolled on the winder 42 will be described.

The part (A) of FIG. 6 is a conceptual view of the rolled-up embossed sheet 40, and the part (B) of FIG. 6 is a sectional view taken along line A-A in the part (A) of FIG. 6. It should be noted that the embossed sheet 40 is spirally rolled up in reality, but in the part (A) of FIG. 6 the roll shape is simply depicted as a concentric shape. In addition, a dark-colored portion in the part (A) of FIG. 6 represents the strip-like base member 24 of the embossed sheet 40, and a light-colored portion represents the resin sheet 20.

On both the end portions of the embossed sheet 40 thus manufactured, the band-like bump portions 34 are formed along the longitudinal direction of the resin sheet 20.

Therefore, as shown by the part (B) of FIG. 6, when the embossed sheet 40 is rolled on the take-up shaft 42A, the band-like bump portions 34 formed on a first turn of an embossed sheet 40A come into contact with the band-like bump portions 34 of a second turn of an embossed sheet 40B. In rolling-up after the second turn, similarly, the band-like bump portions 34 come into contact with the band-like bump portions 34 of a next turn of the embossed sheet 40. As a result, a clearance 41 is formed between roll layers of the rolled-up embossed sheet 40 by the band-like bump portions 34.

Thus, since winding pressure of winding tension when the embossed sheet 40 is rolled up can be borne by the band-like bump portions 34, the winding pressure is not applied to the protrusions 30A of the embossed pattern 30, or, if any, the applied winding pressure can be reduced as compared with an embossed sheet without the band-like bump portions 34. Therefore, since the embossed pattern 30 formed on the sheet surface is prevented from being crushed even when the embossed sheet 40 is rolled up, an original function of the embossed pattern, such as optical performance, can be exerted.

In this case, as shown by the part (B) of FIG. 6, it is preferred that the band-like bump portions 34 includes the protrusions 30A on widthwise both end portions of the embossed pattern 30, and the embossed pattern 30 between the band-like bump portions 34 is treated as a product part. Thus, the protrusions 30A of a first turn of the band-like bump portions 34 come into contact with the extended portions 20A of a second turn of the band-like bump portion 34. As a result, the clearance 41 equal to the thickness of the extended portion 20A is reliably formed between roll layers, namely, between a first turn of the embossed sheet 40 and a second turn of the embossed sheet 40. Therefore, by forming the extended portions 20A whose thickness is equal to the degree of crushing of the protrusions 30A of the embossed pattern 30 when the embossed sheet 40 having no band-like bump portion 34 is rolled up, the embossed pattern 30 can reliably be prevented from being crushed.

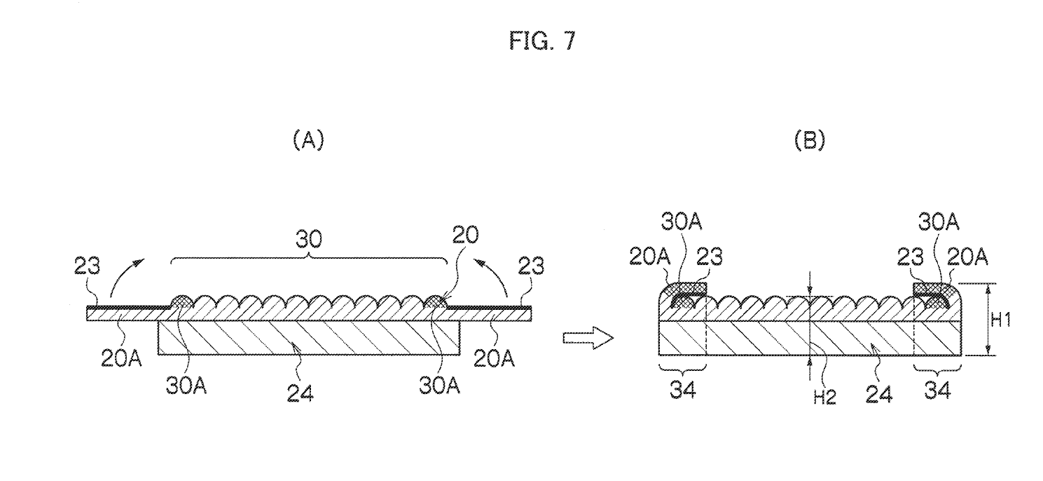

FIG. 7 shows a case where the extended portions 20A are not folded to the rear surface of the strip-like base member 24, but, as indicated by arrows in a part (A) of FIG. 7, folded to overlap with the protrusions 30A on both the end portions of the embossed pattern 30 of the resin sheet 20, and bonded thereto. In this case, it is preferred that a step of applying adhesive 23 to upper faces of the extended portions 20A after separating the strip-like base member 24 laminated with the resin sheet 20 from the separation roller 38 is provided.

Thus, as shown by a part (B) of FIG. 7, the embossed sheet 40 is formed which is provided with a lenticular lens as the embossed pattern 30 and which has the band-like bump portions 34 on both the widthwise end portions of the sheet along the longitudinal direction of the sheet. In this case, also, since winding pressure of winding tension of when the embossed sheet 40 is rolled up can be borne by the band-like bump portions 34, the winding pressure is not applied to the protrusions 30A of the embossed pattern 30, or, if any, the applied winding pressure can be significantly reduced as compared with an embossed sheet having no band-like bump portions 34.

In addition, since in the band-like bump portions 34 formed in the part (B) of FIG. 7 the extended portions 20A overlap with the protrusions 30A, the clearance 41 equal to the thickness of the extended portion 20A can reliably be formed between roll layers, as in the case shown by the part (B) of FIG. 6.

In both the cases in FIG. 4 and FIG. 7, it is preferred that the strip-like base member 24 having higher rigidity than the resin sheet 20 is used as a support. This makes the rigidity of the manufactured embossed sheet 40 higher than that of the resin sheet 20 as a single body. As a result, for example, a first turn of the embossed pattern 30 becomes less likely to sag between the band-like bump portions 34 of the first turn of the embossed pattern 30 when the embossed sheet 40 is rolled up, and therefore the function of the band-like bump portions 34 as bridge beams can be further enhanced. If the rigidity of the embossed sheet 40 is so low that the embossed sheet 40 sags between the band-like bump portions 34, the embossed pattern 30 near the band-like bump portions 34 are not crushed but the embossed pattern 30 distant from the band-like bump portions 34 becomes vulnerable to crushing.

Furthermore, a secondary effect from forming the band-like bump portions 34 on both the end portions of the embossed sheet 40 along the longitudinal direction is that the strip-like embossed sheet 40 can be precisely punched into a predetermined size at a punching process. That is, the strip-like embossed sheet 40 is not directly used as an optical element, but unrolled from the winder 42 and conveyed to a punching process (not shown). In this punching process, the embossed sheet 40 is punched into a predetermined size (for example, 12.7 cm×17.8 cm). In this punching, the embossed sheet 40 is required to be punched parallel to a ridge line of a lenticular lens. In order to punch the embossed sheet 40 parallel with a ridge line of a lenticular lens, an edge position controller (EPC) is used to control travelling of the embossed sheet 40 such that a punching blade becomes parallel with the ridge of the lenticular lens in reference to an end portion of the embossed sheet 40. In this case, the position of the end portion of the embossed sheet 40 is stabilized by providing the band-like bump portions 34, and therefore travelling control performed by the EPC can be stabilized.

As described above, according to the present invention, since the embossed pattern 30 is prevented from being crushed even when the embossed sheet is rolled up, the embossed pattern can exert its original function, such as optical performance. In addition, as a secondary effect of the band-like bump portions 34, the band-like bump portions 34 can be utilized as a reference line for travelling control of the embossed sheet 40 for precise blanking.

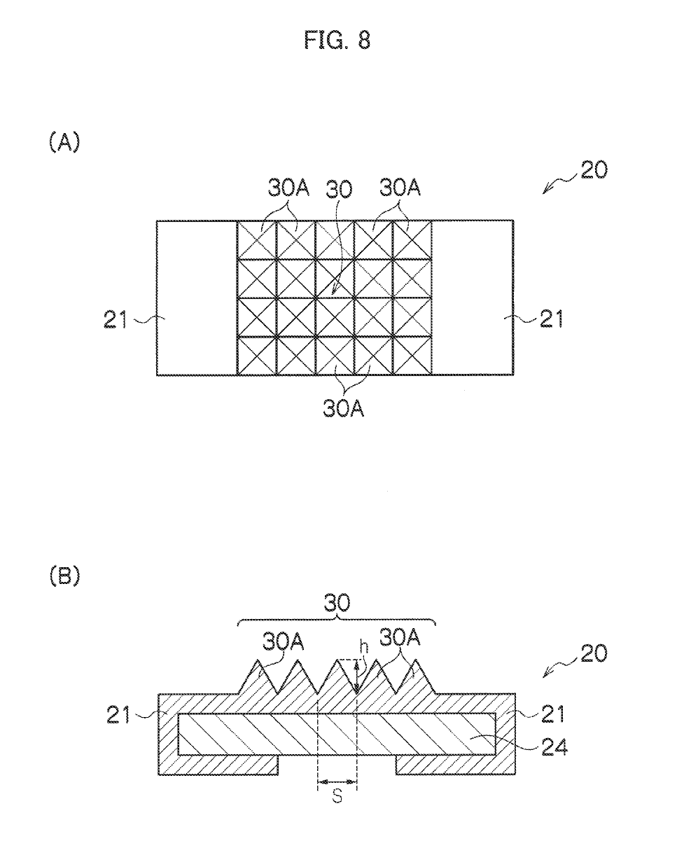

It should be noted that though FIG. 5 illustrates a lenticular lens as an example of the embossed pattern 30, the embossed pattern 30 formed by arranging the protrusions 30A having the shape of a four-sided pyramid in a grid pattern may be used, as shown by parts (A) and (B) of FIG. 8. As shown by the part (B) of FIG. 8, it is preferred that a height h of the four-sided pyramidal protrusion 30A ranges from 20 to 50 μm, and a span S thereof ranges from 10 to 100 μm.

Hereinafter, the strip-like base member 24, the resin sheet 20, the adhesive resin layer 21, and the extrusion die 18 and the respective rollers 26, 28, 38 of the manufacturing apparatus 10 in the present embodiment will be described.

<Strip-Like Base Member>

It is preferred that the strip-like base member 24 has as smooth surface as possible, and has higher rigidity than the resin sheet 20 laminated thereon. In addition, in a case that the embossed sheet 40 to be manufactured is used as an optical element, it is preferred that a transparent strip-like base member 24 is used. Furthermore, the strip-like base member 24 is required to be resistant to the heat of the melt extruded resin sheet 20, and therefore relatively highly heat-resistant polycarbonate resin, polysulfone resin, biaxially-oriented polyethylene terephthalate, or the like can be used. In particular, the biaxially-oriented polyethylene terephthalate is preferred because of its excellent smoothness. Preferably, the strip-like base member 24 has a thickness of 100 μm to 300 μm, more preferably, a thickness of 160 μm to 210 μm.

<Resin Sheet>

Resins that form the resin sheet 20 include, for example, polymethylmethacrylate resin (PMMA), polycarbonate resin, polystyrene resin, methacrylate-styrene copolymer resin (MS resin), acrylonitril styrene copolymer resin (AS resin), polypropylene resin, polyethylene resin, polyethylene terephthalate resin, glycol-modified polyethylene terephthalate resin, polyvinyl chloride resin (PVC), thermoplastic elastomer, or a copolymer thereof, cycloolefin polymer, or the like. In view of ease of melt extrusion, it is preferred that a resin having low melt viscosity is used, such as polymethylmethacrylate resin (PMMA), polycarbonate resin, polystyrene resin, methacrylate-styrene copolymer resin (MS resin), polyethylene resin, polyethylene terephthalate resin, or glycol-modified polyethylene terephthalate resin, and in view of transferability, crack toughness of the sheet, durability of the embossed pattern 30, or the like, it is more preferred that glycol-modified polyethylene terephthalate resin (PETG or the like) is used.

<Adhesive Resin Layer>

The adhesive resin layer 21 is provided with a function for bonding the strip-like base member 24 and the resin sheet 20 together. It is preferred that the adhesive resin layer 21 is further provided with a cushion function. Here, the cushion function means a function of absorbing winding pressure due to winding tension that is applied to the protrusions 30A of the embossed pattern 30 when the embossed sheet 40 is rolled up. Such an adhesive resin layer 21 provided with both adhesiveness and a cushioning property can be modified polyolefin resin, polyester thermoplastic elastomer, or the like. Preferably, the adhesive resin layer 21 has a thickness of 10 μm to 66 μm, more preferably, a thickness of 5 μm to 10 μm.

<Extrusion Die>

It is preferred that the extrusion die 18 has a function of being capable of adjusting the extrusion temperature of the resin sheet 20. That is, the extrusion temperature of the resin sheet 20 extruded from the extrusion die 18 is adjusted and set so that the temperature of the resin sheet 20 at the nip portion P becomes equal to or more than a glass-transition temperature. This is to prevent the nipped resin sheet 20 from being cooled and solidified before the transfer from the die roller 26 is completed. In addition, occurrence of pyrolysis of resin causes such a problem that sheet deterioration occurs in the manufactured embossed sheet 40, and therefore it is preferred that the extrusion temperature of the resin sheet 20 extruded from the extrusion die 18 is set to be as low as possible to the extent that transferring can be performed. In a case where glycol-modified polyethylene terephthalate resin is adopted as a resin material, the discharge temperature of resin from the extrusion die 18 can be in a range of 240 to 300° C., preferably, in a range of 250 to 290° C.

<Each Roller>

As the material for the die roller 26, various iron and steel members, stainless steel, copper, zinc, brass, these metal materials used as core metals and plated with hard chrome (HCr), Cu, Ni, or the like, ceramics, and various composite materials can be adopted.

In addition, as the nip roller 28, various iron and steel members, stainless steel, copper, zinc, brass, or these metal materials used as core metals and having surfaces lined with rubber can be suitably adopted. The nip roller can be provided with a pressure means. In addition, such a configuration that a backup roller further provided on the back side (the opposite side from the die roller) of the nip roller makes it difficult to generate a sag due to reaction force of nip pressure can be adopted.

The separation roller 38 is a roller provided on the opposite side of the die roller 26 from the nip roller 28 so as to face the die roller 26 to separate the surface of the resin sheet 20 from the die roller 26 such that the strip-like base member 24 is wrapped on the separation roller 38. As a material for the separation roller 38, various iron and steel members, stainless steel, copper, zinc, brass, or these metal materials used as core metals and having surfaces lined with rubber can be suitably adopted.

The temperature of the die roller 26 is set such that the temperature of the resin sheet 20 at the nip portion P becomes equal to or more than the glass-transition temperature. This is to prevent the resin sheet 20 from being cooled and solidified before transferring the embossed pattern from the pattern sheet 26 to the resin sheet 20 is completed. On the other hand, in a case where the strip-like base member 24 is separated from the die roller 26 by the separation roller 38, if the bond between the die roller 26 and the resin sheet 20 is too strong, the strip-like base member 24 is unevenly separated and easily deformed into a protrusion shape. Therefore, it is preferred that the temperature of the die roller 26 is set to be as low as possible to the extent that transferring can be performed.

For example, in a case where glycol-modified polyethylene terephthalate resin is adopted as a resin material, the surface temperature of the die roller 26 can be set in a range of 30 to 90° C., preferably, in a range of 40 to 70° C. It should be noted that in order to control the temperature of the die roller 26, a known means, such as filling the inside of the die roller 26 with a heat medium (hot water, oil) and circulating the heat medium, can be adopted.

### First Example

Next, a specific example of a method of manufacturing the embossed sheet of the present invention will be described.

### Example

A die roller 26 which has a diameter of 500 mm and a face length of 1000 mm and which has the embossed pattern shown by the part (A) of FIG. 3 was used. That is, the inverted shape of an embossed pattern 30 of a lenticular lens type with a radius curvature (R) of a protrusion 30A of 150 μm, a height (H) of the projection 30A of 70 μm, a span (S) between the protrusions 30A of 254 μm was formed on the surface of the die roll 26 by machining using a cutting tool.

PETG was used as a resin raw material extruded from an extrusion die 18, and a biaxially-oriented PET (polyethylene terephthalate) film having a thickness of 180 μm and a width of 700 mm was used as a strip-like base member 24.

Then, by using the extrusion die 18 having a width of 1000 mm, a resin sheet 20 having an extruded laminate width of 750 mm was formed by extruding the raw resin from the extrusion die 18, and the resin sheet 20 was nipped by the die roller 26 and a nip roller 28. The extrusion temperature of the extrusion die 18 was set at 280° C., and the temperature of the die roller was set at 40° C. Thus, as shown by the part (A) of FIG. 4, a laminate film with 25 mm wide extended portions 20A extended from widthwise both ends of the strip-like base member 24 was formed.

Next, the formed laminate film was separated from the die roller 26 by the separation roller 38, and thereafter, by using the folding device 35 in FIG. 2, the extended portions 20A of the laminate film were folded in such a manner as shown by the part (B) of FIG. 4. Thus, the embossed sheet 40 was formed and rolled up by the winder 42. The winding tension when the embossed sheet 40 was rolled up was set at 500 N/sheet width.

### Comparative Example

The extruded laminate width was set to 700 mm, but the extended portions 20A were not formed and therefore a folding process was not performed. The other conditions were the same as in the example.

[Test Result]

As a result, when the embossed sheet 40 of the example manufactured with the extended portions 20A was rolled up by the winder 42, the lenticular lens which was the embossed pattern 30 was not crushed, and kept the same height of the protrusion 30A as designed.

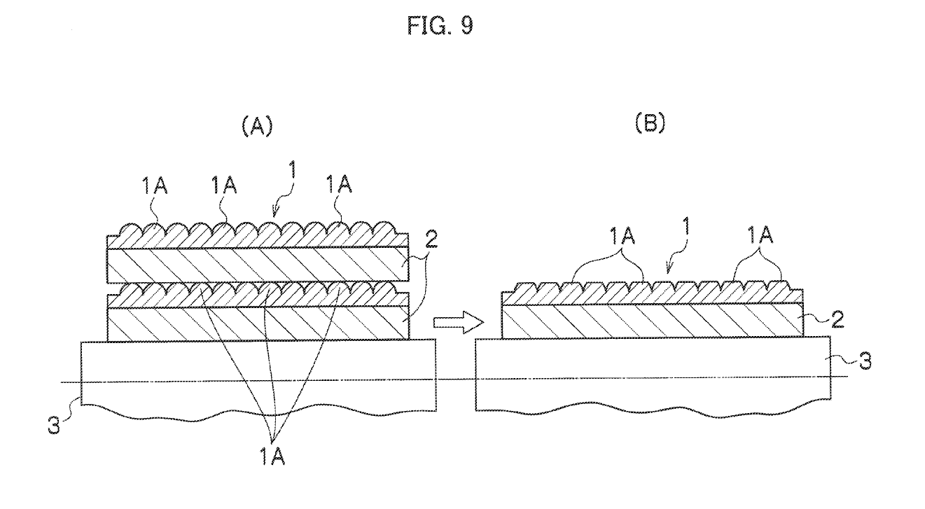

On the other hand, when the embossed sheet 40 of the comparative example manufactured without the extended portions 20A and without performing a folding process was rolled up by the winder 42, the lens lost its shape such that half-round top portions were flatly crushed at a plurality of lengthwise locations of the lenticular lens (see the part (B) of FIG. 9).

### REFERENCE SIGNS LIST

10 . . . manufacturing apparatus for embossed pattern, 12 . . . hopper, 14 . . . Extruder, 16 . . . feed pipe, 18 . . . extrusion die, 19 . . . feed block, 20 . . . resin sheet, 22 . . . feeder, 24 . . . strip-like base member, 26 . . . die roller, 28 . . . nip roller, 30 . . . embossed pattern, 30A . . . protrusion, 32 . . . inverted shape of embossed pattern, 34 . . . band-like bump portion, 38 . . . separation roller, 40 . . . embossed sheet, 42 . . . winder, 42A . . . take-up shaft, P . . . nip point

1. (canceled)

2. An embossed sheet obtained by forming an embossed pattern on a surface of a strip-like sheet and rolled up, comprising:
band-like bump portions thicker than the other portions of the sheet, the band-like bump portions being formed on widthwise both end portions of the sheet along a longitudinal direction of the sheet,
wherein the embossed sheet has a structure where a strip-like base member is laminated on a resin sheet on which the embossed pattern is formed and the band-like bump portions are formed by folding and bonding both end portions of the resin sheet formed to be wider than the strip-like base member to a rear surface of the strip-like base member.

3. The embossed sheet according to claim 2, wherein the band-like bump portions include protrusions on widthwise both end portions of the embossed pattern, and the embossed pattern between the band-like bump portions is produced as a product region.

4. An embossed sheet obtained by forming an embossed pattern on a surface of a strip-like sheet and rolled up, comprising:
band-like bump portions thicker than the other portions of the sheet, the band-like bump portions being formed on widthwise both end portions of the sheet along a longitudinal direction of the sheet,
wherein the embossed sheet has a structure where a strip-like base member is laminated on a resin sheet on which the embossed pattern is formed and the band-like bump portions are formed by folding both end portions of the resin sheet formed to be wider than the strip-like base member to overlap with protrusions on widthwise both end portions of the embossed pattern formed on the resin sheet, and bonding the end portions of the resin sheet to the protrusions.

5. The embossed sheet according to claim 2, wherein the embossed pattern has optical performance.

6. A method of manufacturing an embossed sheet on a sheet surface of which an embossed pattern is formed, comprising:
a strip-like base member supplying step of supplying a strip-like base member from a feeder to a nip point between a die roller and a nip roller;
a resin sheet supplying step of extruding thermoplastic molten resin from an extrusion die into a sheet-like shape, thereby forming a strip-like resin sheet wider than the strip-like base member, and supplying the formed resin sheet to the nip point between the die roller and the strip-like base member;
a transferring step of nipping the resin sheet and the strip-like base member supplied to the nip point by the die roller and the nip roller, thereby laminating the resin sheet on the strip-like base member, and transferring an inverted shape of the embossed pattern formed on the die roller to the resin sheet, and thereafter cooling the resin sheet to solidification;
a separating step of separating the strip-like base member laminated with the resin sheet from the die roller after the transferring step;
a folding step of folding both end portions of the wider resin sheet to a rear surface of the strip-like base member after the separating step;
a bonding step of bonding the folded portions to the strip-like base member; and
a rolling-up step of rolling up the strip-like base member laminated with the resin sheet after the bonding step.

7. The method of manufacturing an embossed sheet according to claim 6, wherein the resin sheet and an adhesive resin layer are coextruded from the extrusion die such that the adhesive resin layer is formed on a rear surface of the resin sheet extruded from the extrusion die.

8. A method of manufacturing an embossed sheet on a sheet surface of which an embossed pattern is formed, comprising:
a strip-like base member supplying step of supplying a strip-like base member from a feeder to a nip point between a die roller and a nip roller;
a resin sheet supplying step of extruding thermoplastic molten resin from an extrusion die into a sheet-like shape, thereby forming a strip-like resin sheet wider than the strip-like base member, and supplying the formed resin sheet to the nip point between the die roller and the strip-like base member;
a transferring step of nipping the resin sheet and the strip-like base member supplied to the nip point by the die roller and the nip roller, thereby laminating the resin sheet on the strip-like base member, and transferring an inverted shape of the embossed pattern formed on the die roller to the resin sheet, and thereafter cooling the resin sheet to solidification;
a separating step of separating the strip-like base member laminated with the resin sheet from the die roller after the transferring step;
a folding step of folding both end portions of the wider resin sheet to overlap with a portion of the embossed pattern on the resin sheet after the separating step;
a bonding step of bonding the folded portions to the overlapped portions of the resin sheet; and
a rolling-up step of rolling up the strip-like base member laminated with the resin sheet after the bonding step.

9. The method of manufacturing an embossed sheet according to claim 6, wherein the rigidity of the strip-like base member is higher than the rigidity of the resin sheet.

10. The embossed sheet according to claim 3, wherein the embossed pattern has optical performance.

11. The embossed sheet according to claim 4, wherein the embossed pattern has optical performance.

12. The method of manufacturing an embossed sheet according to claim 7, wherein the rigidity of the strip-like base member is higher than the rigidity of the resin sheet.

13. The method of manufacturing an embossed sheet according to claim 8, wherein the rigidity of the strip-like base member is higher than the rigidity of the resin sheet.
